(19) United States
(12) Patent Application Publication
(10) Pub. No.: US 2017/0041545 A1
(43) Pub. Date: Feb. 9, 2017

(54) SYSTEMS AND METHODS FOR STABILIZING IMAGES

(71) Applicant: InvenSense, Inc., San Jose, CA (US)

(72) Inventors: Carlo Murgia, San Jose, CA (US); James B. Lim, Saratoga, CA (US); Daniela Hall, Eybens (FR); Romain Fayolle, Grenoble (FR); Mehran Ayat, Los Altos, CA (US)

(21) Appl. No.: 15/231,186

(22) Filed: Aug. 8, 2016

Related U.S. Application Data
(60) Provisional application No. 62/202,121, filed on Aug. 6, 2015.

(51) Int. Cl. H04N 5/232; H04N 5/225

(52) U.S. Cl. CPC H04N 5/23267; H04N 5/2253; H04N 5/23254

(57) ABSTRACT

Systems and methods are disclosed for stabilizing digital images. Sensor representing a condition of the portable device may be obtained and used to classify a context of the portable device based at least in part on the sensor data. One or more stabilization parameters may be determined based on the context and used to stabilize an image captured from an image sensor of the portable device.

### CROSS REFERENCE TO RELATED APPLICATIONS

This application claims priority from and benefit of U.S. Provisional Patent Application Ser. No. 62/202,121, filed Aug. 6, 2015, entitled “GYRO ASSISTED IMAGE PROCESSING,” which is assigned to the assignee hereof and is incorporated by reference in its entirety.

### FIELD OF THE PRESENT DISCLOSURE

This disclosure generally relates to techniques for stabilizing one or more images captured by a portable device and more specifically to determining a context for the portable device and adjusting the stabilization accordingly.

### BACKGROUND

Advances in technology have enabled the introduction of portable devices that feature an ever increasing set of capabilities. Smartphones, for example, now offer sophisticated computing and sensing resources together with expanded communication functionality. Likewise, tablets, wearables, media players and other similar devices have shared in this progress. Notably, it is desirable and increasingly common to provide a portable device with digital imaging functions. However, implementations in a portable device may be particularly susceptible to degradation in quality caused by motion while the video is being recorded. In particular, a camera incorporated into a portable device is often hand held during use and, despite efforts to be still during image recording, shaking may occur. Since such portable devices may also be equipped with motion sensing capabilities, techniques exist for using inertial sensor data to improve the quality of images captured using the portable device to address this issue. For example, video being recorded and/or images captured by the portable device may be stabilized or otherwise compensated using detected motion.

In one example, Electronic Image Stabilization (EIS) is a technique where the quality of an image or video is improved using stabilization methods based on image processing techniques. Electronic Image Stabilization is sometimes also referred to as Digital Image Stabilization (DIS) because it only involves digital image processing techniques. One technique that may be applied to a video stream is to compare the position of subsequent frames to each other and selectively displace them to correct for any movements or vibrations of the device. Similarly, Optical Image Stabilization (OIS) is a technique where the optical element in a camera is moved to compensate the motion of the camera, which is often detected using motion sensors such as e.g. a gyroscope.

Both techniques have their advantages and disadvantages depending on the context in which the photo or video is taken. The context may comprise, for example, the characteristics of the motion of the device or the lighting condition during the recording. Given that a portable device may be equipped with EIS and/or OIS, and either or both systems may have multiple parameters that control their performance, it would be desirable to utilize sensor information to assess the context of the device and adjust the image stabilization being performed to improve quality. Further, it would be desirable to adapt the performance of the image stabilization system(s) in response to changes in the context of the portable device. This disclosure satisfies these and other needs.

### SUMMARY

As will be described in detail below, this disclosure includes a method for processing an image captured using a portable device. The method may involve obtaining data from a sensor representative of a condition of the portable device, establishing a context of the portable device based at least in part on the sensor data, determining a stabilization parameter based at least in part on the detected context and stabilizing an image captured from an image sensor of the portable device based at least in part on the stabilization parameter.

This disclosure also includes a portable device having an image sensor, a context manager for obtaining sensor data and establishing a context of the portable device based at least in part on the sensor data, a stabilization manager for determining a stabilization parameter based at least in part on the context and an image processor for stabilizing an image captured from the image sensor based at least in part on the stabilization parameter.

Further, this disclosure includes a system for stabilizing an image. The system may include a portable device having an image sensor, a context manager for obtaining sensor data and establishing a context of the portable device based at least in part on the sensor data, a stabilization manager for determining a stabilization parameter based at least in part on the context and an image processor for stabilizing an image captured from the image sensor based at least in part on the stabilization parameter. The system may also include an auxiliary device having a motion sensor that outputs data to the context manager of the portable device.

### BRIEF DESCRIPTION OF THE DRAWINGS

FIG. 1 is a schematic diagram of a device for stabilizing a digital image according to an embodiment.

FIG. 2 is a schematic diagram of a device for stabilizing a digital image according to an embodiment.

FIG. 3 is a flowchart showing a routine for stabilizing an image by determining a stabilization parameter according to an embodiment.

FIG. 4 is a schematic diagram depicting stabilization of an image in a sequence according to an embodiment.

FIGS. 5A-D are schematic diagrams depicting the use of sub-frames when capturing an image according to various embodiments.

### DETAILED DESCRIPTION

At the outset, it is to be understood that this disclosure is not limited to particularly exemplified materials, architectures, routines, methods or structures as such may vary. Thus, although a number of such options, similar or equivalent to those described herein, can be used in the practice or embodiments of this disclosure, the preferred materials and methods are described herein.

It is also to be understood that the terminology used herein is for the purpose of describing particular embodiments of this disclosure only and is not intended to be limiting.

The detailed description set forth below in connection with the appended drawings is intended as a description of exemplary embodiments of the present disclosure and is not intended to represent the only exemplary embodiments in which the present disclosure can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the specification. It will be apparent to those skilled in the art that the exemplary embodiments of the specification may be practiced without these specific details. In some instances, well known structures and devices are shown in block diagram form in order to avoid obscuring the novelty of the exemplary embodiments presented herein.

For purposes of convenience and clarity only, directional terms, such as top, bottom, left, right, up, down, over, above, below, beneath, rear, back, and front, may be used with respect to the accompanying drawings or chip embodiments. These and similar directional terms should not be construed to limit the scope of the disclosure in any manner.

In this specification and in the claims, it will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements present.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the exemplary wireless communications devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor. For example, a carrier wave may be employed to carry computer-readable electronic data such as those used in transmitting and receiving electronic mail or in accessing a network such as the Internet or a local area network (LAN). Of course, many modifications may be made to this configuration without departing from the scope or spirit of the claimed subject matter.

The various illustrative logical blocks, modules, circuits and instructions described in connection with the embodiments disclosed herein may be executed by one or more processors, such as one or more motion processing units (MPUs), digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an MPU and a microprocessor, a plurality of microprocessors, one or more microprocessors in conjunction with an MPU core, or any other such configuration.

Unless defined otherwise, all technical and scientific terms used herein have the same meaning as commonly understood by one having ordinary skill in the art to which the disclosure pertains.

Finally, as used in this specification and the appended claims, the singular forms “a, “an” and “the” include plural referents unless the content clearly dictates otherwise.

As noted above, it is increasingly desirable to provide a portable electronic device with one or more digital cameras. This disclosure provides systems and methods for processing an image captured by the portable device to stabilize an image, such as a photograph, or a plurality of images, such as a video stream, obtained using the portable device. Notably, sensor data may be obtained from the portable device that represents a condition of the portable device and used to determine a context. Correspondingly, one or more stabilization parameters may be based on the determined context and applied when processing the image(s) during stabilization.

Many different types of sensors may be used to detect the condition and/or context of the device. For example, a portable device may employ motion sensors, such as for determining orientation of the device to adjust the display of information accordingly as well as for receiving user input for controlling an application, for navigational purposes, or for a wide variety of other applications. Data from such a sensor or plurality of sensors may be used to determine motion of the portable device. The characteristics of the sensed motion may then be used when determining or establishing the context. Notably, context may include one or more aspects of the environment that may affect the portable device and/or may be associated with a manner in which the portable device is being used. Context may also be related to the activity of the user, which may affect how the portable device is being used during the capturing of the image. As an illustration, the sensor data may be used to determine whether the portable device is being moved during image capturing, as well as to what degree and whether the motion has a predictable pattern, such as may result from an intended operation, or is random and/or unintended. In turn, whether as well as how stabilization is to be applied may be adjusted using this information.

The motion of the device depends on many different factors as will be appreciated. The portable device may be handheld or may be mounted to another platform, object or device. When the portable device is handheld, such as a smartphone, the user may be relatively still while taking a photo or video, and any motion may be attributed to unintentional movements of the user's hands. Similarly, the user may be walking or riding in a vehicle, causing relative motion between the user and the objects within the image frame that may be compensated as desired. Still further, the user may be panning the device or otherwise intentionally moving the device to record a larger scene or to track a moving object. Additional examples include situations when the portable device is mounted, with the result that movement of the platform to which it is mounted is translated to the portable device. For example, the portable device may be mounted to a vehicle, such as an automobile or a drone, so that road conditions or the flying environment influence the motion. Motion may also be imparted due to operation of the platform, in the form of vibration or the like. In other situations, the portable device may be mounted to a user, such as on a helmet or harness such that the activities of the user influence the motion.

However, the sensor data is not limited to motion, as other types of data may also be used when determining context. As another illustration, a light sensor may be used to determine ambient conditions under which the photo or video is taken, such as the amount of light available for the image sensors. For example, in low lighting conditions, longer exposure times may be required which cause movement of objects in the scene to result in blurry images. Lack of sharpness in the recorded images may complicate the stabilization technique being employed. To illustrate, blurry objects may create difficulties when aligning the images using EIS. In turn, the averaging of badly aligned image frames may cause ghost structures of duplication of features, which degrade quality.

In addition to the motion sensor and light sensors mentioned above, any other type of sensors that may contribute to the analysis of the context of the device may be used. Context may include information about the general environment, location, and activities of the portable device and the user of the portable device. For example, other sensors may include audio sensors, video sensors, proximity sensors, temperature sensors, humidity sensors, and location sensors such as e.g. GPS sensors. By analyzing the sensor signals from one or more of these sensors, the portable device can determine various types of context: the environmental context such as indoor or outdoor, urban, nature, the social context such as restaurant, bar or party, or the activity context whether the user is still, walking, running, or in transportation and the type of transportation. As will be discussed in further detail below, the context may be changing or dynamic, which also influences the image processing and settings.

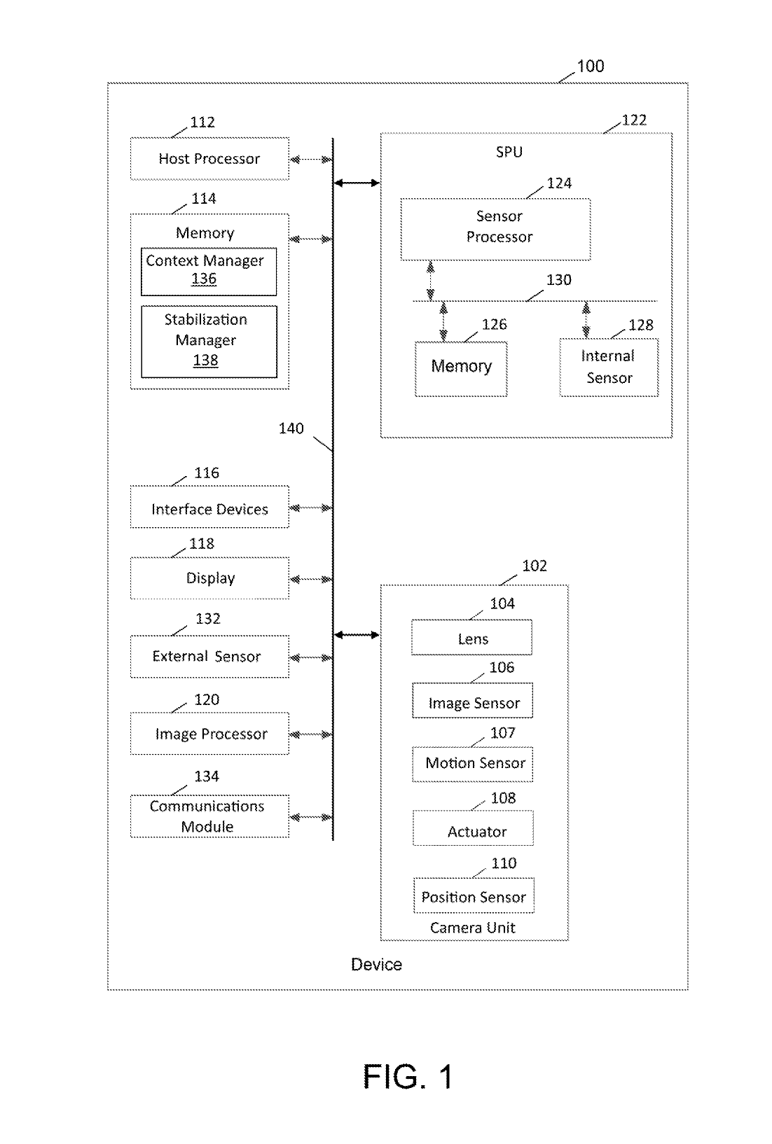

To help illustrate these and other aspects of the disclosure, details regarding one embodiment of a portable electronic device 100 are depicted as high level schematic blocks in FIG. 1. As will be appreciated, device 100 may be implemented as a device or apparatus, such as a handheld device that can be moved in space by a user and its motion and/or orientation in space therefore sensed. For example, such a handheld device may be a portable phone (e.g., cellular phone, a phone running on a local network, or any other telephone handset), wired telephone (e.g., a phone attached by a wire), personal digital assistant (PDA), video game player, video game controller, (head-mounted) virtual or augmented reality device, navigation device, activity or fitness tracker device (e.g., bracelet or clip), smart watch, other wearable device, portable internet device (MID), personal navigation device (PND), digital still camera, digital video camera, binoculars, telephoto lens, portable music, video, or media player, remote control, or other handheld device, or a combination of one or more of these devices.

Device 100 includes a camera unit 102 configured for capturing images. The camera unit 102 includes at least an optical element, such as, for example, a lens 104, which projects the image onto an image sensor 106. The camera unit 102 may optionally be capable of performing optical image stabilization (OIS). Typically, OIS systems include processing to determine compensatory motion of the lens in response to sensed motion of the device or part of the device, such as e.g. the camera (body), actuators to provide the compensatory motion in the image sensor or lens, and position sensors to determine whether the actuators have produced the desired movement. The camera unit 102 may include dedicated motion sensors 107 to determine the motion, or may obtain the motion from another module in the device, such as a sensor processing unit (SPU) 122 that may include motion sensors as described below. In an embodiment that features OIS, the camera unit includes an actuator 108 for imparting relative movement between lens 104 and image sensor 106 along at least two orthogonal axes. Additionally, a position sensor 110 may be included for determining the position of lens 104 in relation to image sensor 106. Since OIS capabilities are optional, the corresponding elements are indicated with dashed boxes. Motion sensing may be performed by a general purpose sensor assembly as described below according to techniques disclosed in co-pending, commonly owned U.S. patent application Ser. No. 14/524,807, filed Oct. 27, 2014, which is hereby incorporated by reference in its entirety. In one aspect, actuator 108 may be implemented using voice coil motors (VCM) and position sensor 110 may be implemented with Hall sensors, although other suitable alternatives may be employed.

Device 100 may also include a host processor 112, memory 114, interface device 116 and display 118. Host processor 112 can be one or more microprocessors, central processing units (CPUs), or other processors which run software programs, which may be stored in memory 114, associated with the functions of device 100. Interface devices 116 can be any of a variety of different devices providing input and/or output to a user, such as audio speakers, buttons, touch screen, joystick, slider, knob, printer, scanner, computer network I/O device, other connected peripherals and the like. Display 118 may be configured to output images viewable by the user and may function as a viewfinder for camera unit 102. Further, the embodiment shown features dedicated image processor 120 for receiving output from image sensor 106 as well as controlling the OIS system, although in other embodiments, any distribution of these functionalities may be provided between host processor 112 and other processing resources of device 100. For example, camera unit 102 may include a processor to analyze the motion sensor input and control the actuators. Image processor 120 or other processing resources may also apply stabilization and/or compression algorithms to the captured images as described below.

Accordingly, multiple layers of software can be provided in memory 114, which may be any combination of computer readable medium such as electronic memory or other storage medium such as hard disk, optical disk, etc., for use with the host processor 112. For example, an operating system layer can be provided for device 100 to control and manage system resources in real time, enable functions of application software and other layers, and interface application programs with other software and functions of device 100. Similarly, different software application programs such as menu navigation software, games, camera function control, image processing or adjusting, navigation software, communications software, such as telephony or wireless local area network (WLAN) software, or any of a wide variety of other software and functional interfaces can be provided. In some embodiments, multiple different applications can be provided on a single device 100, and in some of those embodiments, multiple applications can run simultaneously.

Device 100 also includes a general purpose sensor assembly in the form of integrated sensor processing unit (SPU) 122 featuring sensor processor 124, memory 126 and internal sensor 128, that may communicate over sensor bus 130. Memory 126 may store algorithms, routines or other instructions for processing data output by internal sensor 128 and/or other sensors as described below using logic or controllers of sensor processor 124, as well as storing raw data and/or motion data output by internal sensor 128 or other sensors. Internal sensor 128 may be one or more sensors for measuring motion of device 100 in space. In embodiments where internal sensor 128 is a motion sensor SPU 122 may also be referred to as Motion Processing Unit (MPU). Depending on the configuration, SPU 122 measures one or more axes of rotation and/or one or more axes of acceleration of the device. In one embodiment, at least some of the motion sensors are inertial sensors, such as rotational motion sensors or linear motion sensors. For example, the rotational motion sensors may be gyroscopes to measure angular velocity along one or more orthogonal axes and the linear motion sensors may be accelerometers to measure linear acceleration along one or more orthogonal axes. In one aspect, the gyroscopes and accelerometers may each have 3 orthogonal axes, such as to measure the motion of the device with 6 degrees of freedom. The signals from the sensors may be combined in a sensor fusion operation performed by sensor processor 124 or other processing resources of device 100 provides a six axis determination of motion. The sensor information may be converted, for example, into an orientation, a change of orientation, a speed of motion, or a change in the speed of motion. The information may be deduced for one or more predefined axes, depending on the requirements of the system. As desired, internal sensor 128 may be implemented using MEMS to be integrated with SPU 122 in a single package. Exemplary details regarding suitable configurations of host processor 112 and SPU 122 may be found in co-pending, commonly owned U.S. patent application Ser. No. 11/774,488, filed Jul. 6, 2007, and Ser. No. 12/106,921, filed Apr. 21, 2008, which are hereby incorporated by reference in their entirety. Further, SPU 122 may be configured as a sensor hub by aggregating sensor data from additional processing layers as described in co-pending, commonly owned U.S. patent application Ser. No. 14/480,364, filed Sep. 8, 2014, which is also hereby incorporated by reference in its entirety. Suitable implementations for SPU 122 in device 100 are available from InvenSense, Inc. of San Jose, Calif. Thus, SPU 122 may be configured to provide motion data for purposes independent of camera unit 102, such as to host processor 112 for user interface functions, as well as enabling OIS functionality. Any, or all parts of the SPU may be combined with image processor 120 into a single chip or single package, and may be integrated into the camera unit 102. Any processing or processor needed for the actuator 108 control or position sensor 110 control, may also be included in the same chip or package.

Device 100 may also include other sensors as desired, including any number of sensors configured as internal sensors of SPU 122. Alternatively, or in addition, one or more sensors may be configured as external sensor 132, with resulting data output communicated over bus 140, described below, to host processor 112, sensor processor 124 or other processing resources in device 100. As used herein, “external” means a sensor that is not integrated with the SPU. Any combination of internal and external sensors may provide sensor data about the environment surrounding device 100. For example, sensors such as one or more pressure sensors, magnetometers, temperature sensors, infrared sensors, ultrasonic sensors, radio frequency sensors, position sensors such as GPS, or other types of sensors can be provided. In one embodiment, data from a magnetometer measuring along three orthogonal axes may be fused with gyroscope and accelerometer data to provide a nine axis determination of motion. Further, a pressure sensor may be used as an indication of altitude for device 100, such that a sensor fusion operation may provide a ten axis determination of motion. Device 100 may also receive sensor data from other devices that may be associated with the user. For example, device 100 may be implemented as a smartphone and may receive data from a device having sensing capabilities worn by the user, such as an activity bracelet, watch or glasses. Accordingly, device 100 may include communications module 134 to transmit and/or receive relevant information.

In the embodiment shown, camera unit 102, SPU 122, host processor 112, memory 114 and other components of device 100 may be coupled through bus 140, which may be any suitable bus or interface, such as a peripheral component interconnect express (PCIe) bus, a universal serial bus (USB), a universal asynchronous receiver/transmitter (UART) serial bus, a suitable advanced microcontroller bus architecture (AMBA) interface, an Inter-Integrated Circuit (I2C) bus, a serial digital input output (SDIO) bus, a serial peripheral interface (SPI) or other equivalent. Depending on the architecture, different bus configurations may be employed as desired. For example, additional buses may be used to couple the various components of device 100, such as by using a dedicated bus between host processor 112 and memory 114.

As noted above, multiple layers of software may be employed as desired and stored in any combination of memory 114, memory 126, or other suitable location. For example, a motion algorithm layer can provide motion algorithms that provide lower-level processing for raw sensor data provided from the motion sensors and other sensors. A sensor device driver layer may provide a software interface to the hardware sensors of device 100. Further, a suitable application program interface (API) may be provided to facilitate communication between host processor 112 and SPU 122, for example, to transmit desired sensor processing tasks. Other embodiments may feature any desired division of processing between SPU 122 and host processor 112 as appropriate for the applications and/or hardware being employed. For example, lower level software layers may be provided in SPU 122 and an API layer implemented by host processor 112 may allow communication of the states of application programs as well as sensor commands. Some embodiments of API implementations in a motion detecting device are described in co-pending U.S. patent application Ser. No. 12/106,921, incorporated by reference above. In particular, device 100 may include context manager 136 and stabilization manager 138 for determining the context of the portable device 100 and for setting or adjusting stabilization parameters based on the context as described in further detail below. Accordingly, context manager 136 and stabilization manager 138 may comprise instructions stored in a suitable location, such as memory 114 as shown, that may be executed by image processor 120. In other embodiments, the instructions may be stored in any storage resource(s) and similarly may be executed by any processing resource(s). Further, it should be appreciated that context manager 136 and/or stabilization manager 138 may be implemented using any suitable architecture and may be any combination of software, firmware or hardware.

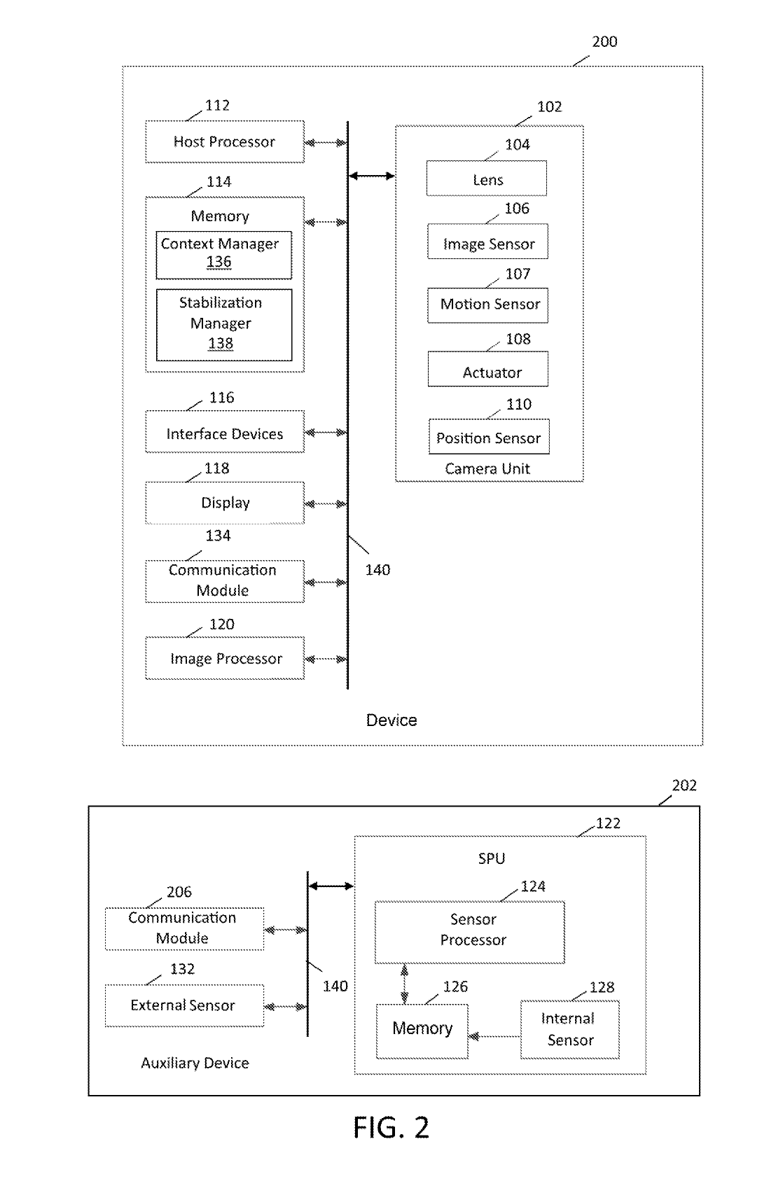

Another embodiment of this disclosure may include a system for stabilizing an image wherein portable device 200 receives sensor data from an auxiliary device 202 as schematically depicted in FIG. 2. Portable device 200 may share many features with portable device 100 and similar elements have the same numbering. As noted above, auxiliary device 202 may be associated with the user of portable device 200. For example, auxiliary device 202 may be a wearable, such as an activity bracelet, a watch, glasses or the like. Auxiliary device may have at least one sensor that is used by context manager 136 to establish a context for device 200. In the embodiment shown, auxiliary device has a motion sensor implemented through SPU 122 and/or digital sensor 134. Sensor data may be shared between portable device 200 and auxiliary device 202 through communications modules 134 and 206, respectively. For example, a shorter range, low power communication protocol such as BLUETOOTH®, ZigBee®, ANT or a wired connection may be used or a longer range communication protocol, such as a transmission control protocol, internet protocol (TCP/IP) packet-based communication, accessed using a wireless local area network (WLAN), cell phone protocol or the like may be used.

In some embodiments of the inventions, the portable device may include a SPU 122 as depicted in FIG. 1, and in addition may communicate with an external device that comprises sensors and an SPU, such as through communication module 134. The context information is then derived by combining the information from the sensors in the portable device and the sensors in the external device. The portable device may be in constant communication with the external device to gather the sensor information, or may send a request for information to the external device when context information is needed, for example when starting an imaging application on the portable device, or when starting a video recording. The portable device may only request information from the external device, if based on the sensors in the device, the context cannot be unambiguously determined. The external device may determine the context continuously and provided the information to the portable device when requested, or may only activate the sensors to determine the context when requested. This latter option may use less power, but may lead to some latency in the response. The option that is used may also depend on the power status or settings of the external device. The portable device may inform the external device that it is recording a video stream, and that the external device should inform the portable device if the context changes.

In the described embodiments, a chip is defined to include at least one substrate typically formed from a semiconductor material. A single chip may be formed from multiple substrates, where the substrates are mechanically bonded to preserve the functionality. A multiple chip includes at least two substrates, wherein the two substrates are electrically connected, but do not require mechanical bonding. A package provides electrical connection between the bond pads on the chip to a metal lead that can be soldered to a PCB. A package typically comprises a substrate and a cover. Integrated Circuit (IC) substrate may refer to a silicon substrate with electrical circuits, typically CMOS circuits. MEMS cap provides mechanical support for the MEMS structure. The MEMS structural layer is attached to the MEMS cap. The MEMS cap is also referred to as handle substrate or handle wafer. In the described embodiments, an MPU may incorporate the sensor. The sensor or sensors may be formed on a first substrate. Other embodiments may include solid-state sensors or any other type of sensors. The electronic circuits in the MPU receive measurement outputs from the one or more sensors. In some embodiments, the electronic circuits process the sensor data. The electronic circuits may be implemented on a second silicon substrate. In some embodiments, the first substrate may be vertically stacked, attached and electrically connected to the second substrate in a single semiconductor chip, while in other embodiments the first substrate may be disposed laterally and electrically connected to the second substrate in a single semiconductor package.

As one example, the first substrate may be attached to the second substrate through wafer bonding, as described in commonly owned U.S. Pat. No. 7,104,129, which is incorporated herein by reference in its entirety, to simultaneously provide electrical connections and hermetically seal the MEMS devices. This fabrication technique advantageously enables technology that allows for the design and manufacture of high performance, multi-axis, inertial sensors in a very small and economical package. Integration at the wafer-level minimizes parasitic capacitances, allowing for improved signal-to-noise relative to a discrete solution. Such integration at the wafer-level also enables the incorporation of a rich feature set which minimizes the need for external amplification.

In the described embodiments, raw data refers to measurement outputs from the sensors which are not yet processed. Depending on the context, motion data may refer to processed raw data, which may involve applying a sensor fusion algorithm or applying any other algorithm. In the case of a sensor fusion algorithm, data from one or more sensors may be combined to provide an orientation or orientation change of the device. In the described embodiments, an MPU may include processors, memory, control logic and sensors among structures.

As noted above, image(s) captured by camera unit 102 may be shaky due to unintended movements of device 100. A variety of stabilization techniques may be applied to stabilize the captured image(s). In one aspect, the stabilization technique may involve OIS as described above to generate a compensating relative movement between image sensor 106 and lens 104 in response to detected movement of device 100. In this case, any captured images may have been stabilized already due to the motion of the lens. This allows compensation for small movements of the camera and is limited by the displacement limitations of the actuators. In another aspect, the stabilization technique may involve processing operations known in the art as electronic image stabilization (EIS), where the image sensor captures/records images without any prior (optical) stabilization. Electronic Image Stabilization is sometimes also referred to as Digital Image Stabilization (DIS) because it only involves digital image processing techniques. As known in the art, this is an image processing technique where, for example, at least two captured images are employed with one serving as a reference. By comparing the second image, it may be determined whether one or more pixels have been translated or “shifted.” To the extent such translation is due to unintended motion of device 100, the second image may be adjusted to generate a stabilized image that minimizes the amount the one or more pixels are shifted, since in the absence of intended movement of the camera and movement of objects in the scene, the pixels should be identical (neglecting camera sensor noise). In another aspect, motion of device 100 may be detected by a suitable sensor assembly, such as SPU 122, while an image is being captured. Accordingly, the characteristics of that motion may be used to adjust the captured image by shifting the pixels by an amount that compensates for the detected motion to generate a stabilized image. These techniques may be referred to as gyroscope assisted image stabilization, or gyroscope assisted EIS, since gyroscope sensors are often used to measure the motion. The gyroscope may be incorporated with the camera unit, such as motion sensor 107, or may be integrated in SPU 122. As desired, one or any combination of these and other techniques may be used to stabilize images.

Motion can affect the captured images or image streams in different way, and these influences or parasitic effects may be separated in two different classes or types: intra-frame and inter-frame. Intra-frame effects are caused by motion during the capture or recording of a single image frame, and inter-frame effects are caused by motion from one frame to another. Intra-frame motion has a smaller time scale than inter-frame motion, and therefore is usually related to faster or higher frequency motion. Inter-frame motion leads to inter-frame shaking and may make image streams or videos uncomfortable to watch, because of exaggerated displacement of objects over time (jittering or shaking). However, the individual frames are geometrically correct and look unaffected, not considering motion blur of objects, for example in low light. These effects may be created by relatively low-frequency (or continuous) motion, typically a few Hz max, and is generally the most visible component of video captured by portable devices such as e.g. smartphone. Intra-frame motion may induce geometrical distortions of objects and are most commonly referred to as “rolling-shutter effect”. These effect occur in most current commodity imagers based on CMOS technology, in which pixels lines are exposed and read-out sequentially, one after the other. This means that during the readout the object may move which leads to a distorted image capture. Technologies for avoiding this do exist, such as CCD image sensors, or some special CMOS “global shutter” sensors, but these are far more expensive and largely unused in consumer electronics.

The distinction between inter- and intra-frame shakes and effects can be made based on a comparison of frame exposure duration (usually of the order of several milliseconds) and the motion characteristic. Therefore, intra-frame effect are usually caused by high frequency motion of vibrations. For example, these effects may occur in transportation use cases such as e.g. a car or drone, where high-frequency vibrations from an engine, propeller or oscillating structure is transmitted directly or indirectly to the camera. However significant unwanted distortions can also occur when performing a fast-pan or under a strong hand-shake.

As part of the context analysis, the motion captured by the motion sensors may be analyzed in order to determine the motion characteristics and the presence of intra-frame and inter-frame effects. For example, a frequency analysis of the motion may be performed, and based on the quantity of energy at the different frequencies the (relative) presence of the intra-frame and inter-frame effects may be predicted. This means that at least one frequency range is defined and the motion analysis is used to determine how much of the motion falls in that frequency range. The amount of motion may be quantified, for example, by determining the energy per frequency range or the average motion amplitude in that frequency range. The selected frequency ranges may be predefined, may be adapted to the user or the use case, or may be influenced by the context. Each frequency range may influence one or more stabilization parameters. Thresholds may be used so that only when the energy in a certain frequency ranges is above a threshold, the stabilization parameters are affected or modified. The energy in the frequency range may also directly influence the value of the stabilization parameter. For example, the higher the energy in a certain frequency range, the higher the cropping percentage of the image becomes. When motion is slow enough so that the camera orientation does not change significantly (typically has not rotated more than a few degrees in any direction) during frame exposure, one can consider that intra-frame shake can be neglected. Inversely, when the mean camera orientation does not change significantly over a frame expose time, inter-frame effects may be small or may be neglected, even if high frequency and high amplitude vibrations are occurring and frames are intensely distorted.

Based on the above, image stabilization may also be separated into two different classes: intra-frame image stabilization and inter-frame image stabilization, and each class may have its own set of stabilization parameters. Based on the determined context including motion analysis, the relative importance and weights of these different classes of stabilization may be determined. When intra-frame effects are not present or may be neglected, intra-frame stabilization may be turned on, and only inter-frame stabilization may be applied, and vice-versa. Alternatively, the relative weight of intra-frame stabilization and inter-frame stabilization may be based on the energy of motion in their respective frequency ranges. For example, certain frequency ranges may be correlated to intra-frame stabilization and other frequency ranges may be correlated to inter-frame stabilization, and the amount of motion in those frequency ranges may influence the respective stabilization parameters. Switching off unrequired stabilization may also reduce the use of power and processing resources.

Intra-frame stabilization and inter-frame stabilization may require different stabilization processes. Inter-frame stabilization consists in determining global transforms at image or frame scale (such as e.g. homographies) that fit best with the virtual image orientation change that corresponds to the measured motion. EIS is most suited for this type of stabilization. OIS can also handle slow motion but is limited in most cases in terms of amplitude (typically 1°) due to the limited motion range of the actuators. Therefore, if based on the context/motion analysis it is determined that inter-frame stabilization may be required, EIS may be activated.

Intra-frame stabilization requires to first reconstruct the “trajectory” of the camera during the image capture with a high temporal resolution and accuracy. For example, if the image capture duration is 5 ms and image is e.g. 1920×1080 pixels, successive lines are exposed with 4.63 μs delay. Therefore, one needs to compute the adequate transform for each pixel line of the image based on the targeted “virtual orientation” of the camera. The virtual orientation of the camera represents a fixed orientation, corrected for the motion, for example, such as the orientation at the beginning of image capture, or at the delivery of an electronic sync signal. The image processing techniques required for the ‘digital’ intra-frame stabilization require heavy computation resources. Therefore, in these situations or use cases the use of OIS is preferred since the correction is at the source and it allows to actually construct an image which is at the source (mostly) free of these unfortunate effects. It has to be noted that DIS is especially not very suitable for handling high-frequency wobbling, since visual analysis has to be performed on very local areas of the image to properly map the distortion. In a lot of real scenes, such computation can be difficult, and at least very computationally expensive.

The settings of the sensors may also be adapted based on the detected context and the required stabilization. As mentioned above, for inter-frame stabilization an average or virtual camera orientation or quaternion needs to be determined. For this calculation, the motion sensors are typically required to operate at a sampling rate or output data rate (ODR) comparable to the image frame rate. For stabilizing situations with a significant amount of intra-frame shakes (generally coming on top of inter-frame shakes), the motion sensors typically require operation at a sampling rate at least 5 to 10 times higher than the highest frequency with significant energy, in order to be able to interpolate a sine wave matching with the motion, and ultimately compute an acceptable estimate for the camera trajectory during frame exposure. Thus, depending on the context and the required stabilization, the settings of the (motion) sensors, such as e.g. output data rate or full scale range, may be adapted, which means that the sensor settings or parameters can be regarded as stabilization parameters. The sensor settings may also be adapted depending on the required frequency range in order to provide adequate and accurate measurements.

Motion sensor, and other sensor, may take a lot of power resources to operate, especially at high output data rates. Therefore, if power use is a concern, the sensors should only be used in the stabilization process if a significant improvement of stabilization quality is obtained compared to when the motion sensors are not used. The decision whether or not to use the motion sensors may be made based on the context and/or past stabilization results. In some embodiment, the stabilization may be performed with and without the help of the motion sensors in order to make a decision on the use of the sensors (assuming the context or stabilization requirements do not change). These two stabilization processes, with and without motion sensors, may be done in parallel or in series (one after each other), and based on the stabilization results or quality, a decision may be made to keep using the motion sensors or not. An ongoing stabilization process may use motion sensors, but once in a while, for a short period, the motion sensors maybe switched of, or a parallel process not using the motion sensors may be activated, in order to check if the sensors really improve the stabilization process. Opposite strategies may also be used, where the motion sensors are turned on briefly to check if their use improves the stabilization. Verifying the efficiency of the motion sensors in the stabilization process may also include modifying or varying the settings of the sensors. A certain threshold of quality improvement may be set in order to justify the use of the motion sensor and the associated extra power resources.

The stabilization algorithm may be applied as the images are being captured or may be performed as a post-processing operation by using sensor data that was obtained during recording. The stabilization algorithm may also be referred to as motion-compensation, or compensation algorithm. As will be appreciated, post-processing stabilization may allow use of enhanced resources that may not be available to portable device 100, such as increased processing and/or power. Additionally, a more time consuming stabilization technique may result in improved quality as compared to a stabilization technique that is applied as the images are being captured. In copending U.S. patent application Ser. No. 14/718,819, filed May 21, 2015, which is entitled “SYSTEMS AND METHODS FOR STORING IMAGES AND SENSOR DATA,” which is assigned to the assignee hereof and is incorporated by reference in its entirety, techniques are described for storing contemporaneous motion sensor data along with images. The stored motion sensor data may be used to determine a context for the portable device as described in this disclosure. Additionally, or in the alternative, the context may be determined contemporaneously and stored with the images for later use when processing the captured image(s). Whether the stabilization is performed as the image is being recorded, in a post-processing operation, or both, one or more stabilization parameters may be applied. As used herein, a stabilization parameter is any setting that controls or affects how the image is stabilized. At a general level, the stabilization parameter may be which technique or combination of techniques (e.g., EIS, OIS, or other) are applied. Any other types of context-dependent compensation algorithms or context-dependent image processing algorithm may also be applied in a similar matter.

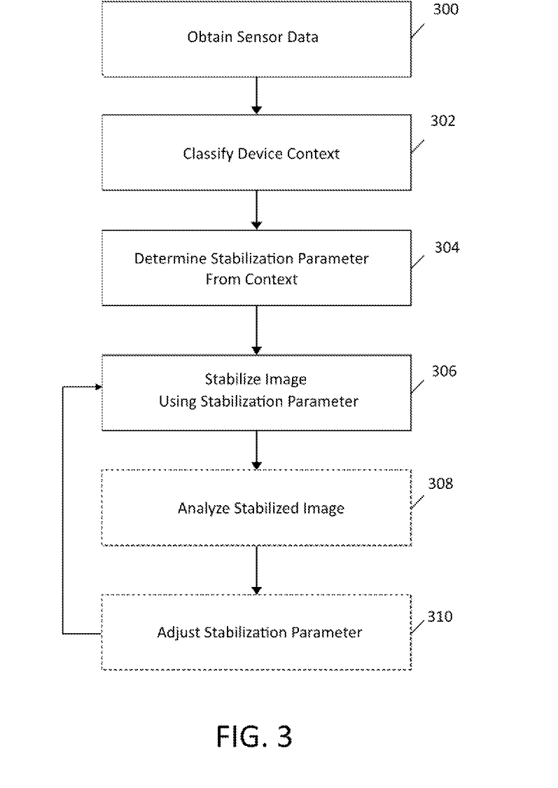

To help illustrate aspects of this disclosure, an exemplary routine for stabilizing images captured using device 100 is represented by the flowchart shown in FIG. 3. Beginning with 300, data may be obtained that represents a condition of the device from a sensor. Based at least in part on the sensor data, a context may be established for the device in 302. Next, in 304, a stabilization parameter may be determined based at least in part on the context. In 306, the stabilization parameter may be used to stabilize an image captured by device 100.

For example, the context may be determined based on input received from sensors in the device, such as by context manager 136, which receives information from sensors, such as raw data from sensors 107, 128, and/or 132, and other information as desired. In one aspect, the information may be pre-processed information, such as from SPU 122, that represents one or more layers of processing that may occur prior to being passed to context manager 136. As one, non-limiting example, SPU 122 (or other processing resources) may have already analyzed signals from the motion sensors to determine the activity of the user, which in turn may be used to assign a context classification for device 100. Alternatively, such pre-processed information may be passed directly to stabilization manager 138 if the determined activity is used as a context for the device. Context manager 136 may also receive external information, such as from sensors incorporated in other devices associated with the user, as noted above, as well as other types of information. Context manager 136 may determine the context in a continuous manner, continuously processing the sensor data, or may only determine the context when significant changes in the sensor data are observed. In case context manager 136 receives context data from, for example, SPU 122, the SPU may communicate the context data regularly, e.g. at a predefined time interval, or SPU may only communicate changes in the context determined by the SPU. The context manager 136 may send out a request for context data, for example when starting an image application. In one aspect, the context may be based at least in part on a determined location of portable device 100, such that one or more stabilization parameters may be associated with a specific location, which may be determined in any suitable manner, including by employing crowd sourcing techniques.

The established context may then be passed to stabilization manager 138 to determine one or more stabilization parameters based on the context. The stabilization manager 138 may contain, or may access, a look-up table or list that specifies the stabilization parameters as a function of the context. Different detected contexts may have similar stabilization parameters. Different components or blocks of the stabilization process may have separate tables, such as e.g. a separate table for EIS settings and for OIS settings. In case no stabilization parameters are predefined or available or a certain detected context, a default stabilization parameters setting may be used. Stabilization manager 138 may also receive information from image processor 120 that may be configured to analyze output of image sensor 106. As discussed above, motion of objects within an image frame may be used to set stabilization parameters, which may be determined by this analysis. The stabilization settings in the table may be updated or adjusted to the user or based on user preferences.

In some embodiments, establishing a context for portable device 100 may include a classification operation according to predefined sensor characteristics. Alternatively, or in addition, analysis of the motion characteristics could be used to determine the quantity of energy in different frequency ranges over a certain frequency spectrum. The energy at a certain frequency range may be interpreted as the stabilization requirement at the frequency range. Based on the energy distribution over the spectrum, a set of stabilization parameters may be determined. For example, a look-up-table may contain predefined responses and suitable parameters for various “patterns” of energy distribution (or mean amplitude) across the spectrum, such that for each energy pattern an associated set of stabilization parameters can be found. Stored energy patterns may be combined in order to corresponds to the measured energy pattern, which means that also the corresponding sets of stabilization parameters may be combined.

In one aspect, suitable parameters for EIS include control over the amount of cropping, the maximum amplitude of displacement of the images, temporal filtering parameters, or the spatial correction (warping) parameters of the images. For example, if a user is walking, the crop percentage may be increased to create more margin around the image. Another parameter that may be varied is the maximum amount an image is moved with respect to previous or subsequent images, which may be considered to correspond to the stabilization strength. As long as the motion of the device from one to the next frame is smaller than the maximum allowable correction distance, the EIS can stabilize the movement. The number of adjacent image frames, sub-frames, or segments that are analyzed or taken into consideration may also be adjusted. The context may also influence the weights of the different image frames in the calculations.

In addition to the above, another suitable stabilization parameter for OIS includes the maximum amplitude of the actuators. For embodiments that include both EIS and an OIS module, another exemplary parameter may be selection between the systems. Conditions may be defined for which only one of the systems is activated, as wells as conditions in which both are activated at varying degrees. Accordingly, the relative weighting between EIS and OIS techniques may vary from all EIS and no OIS to no EIS and all OIS. In one illustration, the EIS may be switched off and the OIS may be active for low light conditions, irrespective of the motion or activity of the device. Alternatively, the EIS may be turned on in low light if low motion is detected. In normal light conditions, the EIS may always be on, and the OIS may be on unless there is too much motion or shaking, such as if the user is walking. The system may analyze the motion, and based on the known hardware specifications of the OIS, decide if the OIS is able to compensate the movement, or if the movements are of too large amplitude or too high frequency for the OIS system. In some implementations, one or more of the stabilization parameters may be stored in a lookup table and linked to a context classification. Adaption of the parameters may also have an anisotropic response where the settings of the different axes, different directions, or different types of motion (rotational vs. translational, or vertical vs. horizontal) are controlled or adapted differently.

The image stabilization process as depicted in FIG. 3 may optionally comprise a feedback mechanism the determine the quality and efficiency of the ongoing image stabilization. The feedback mechanism may be used to optimize the stabilization parameters for different context, and for different users in particular context. As shown, in 308 an analysis operation is performed on the stabilized image obtained in 306. In case EIS is used that already required image analysis in order to determine the required stabilization, this extra step of quality verification does not come at a large extra computational cost. Based on this analysis, stabilization manager 138 may adjust the stabilization parameter as warranted in 310 and the routine may return to 306 to stabilize the image using the adjusted stabilization parameter. The optional operations associated with 308 and 310 are represented using dashed boxes as shown. Image processor 120 may also be used to determine the quality of the image stabilization, for example by comparing the raw image data to the stabilized image data. The analysis may be done to analyze the stabilization quality of individual images, such as e.g. blurring within the image, but also the stabilization quality of a video stream of multiple images, such as e.g. jittering of subsequent images or objects in the images. The feedback of the quality of the stabilization may be used to adjust the stabilization parameters as a function of the detected context parameters. When analyzing the performance of OIS, the residual image effects or artifacts may be used to setup additional EIS to remove the residual artifacts. The adjustment may be done immediately, or the adjustments may be stored and made for future stabilization. The quality of the stabilization may be analyzed using various image properties, such as using the contrast, blurriness, (vibrational) movement of objects in the image, etc. The quality analysis may be done as the images are stabilized (online), or at a later time (offline), for example, when the device is not in use or is charging. The quality analysis may be done by comparing the stabilized images to the raw un-stabilized images, or may be done based on the stabilized images only.

The stabilization quality analysis may be done on the incoming image stream, and modification of the stabilization parameters may be done instantly, but gradually. Once these modifications have been made, the analysis continues to see if the modifications that were made indeed resulted in better stabilization. Stabilization parameters may be adapted one by one, or several at once but this would make it less clear to define the influence of the individual parameters.

In some embodiments, several sets of stabilization parameters may be applied to different video streams or sub-video streams. This would mean that the raw video stream is split in e.g. 2 or 3 video streams and a different sets of stabilization parameters are applied to the different streams. Using the stabilization quality analysis, it is then determined which set of stabilization parameters gives the best stabilization results. As mentioned above, the testing of the different stabilization options may also include verification if the use of e.g. motion sensors improves the stabilization quality enough to justify the use of extra power resources. Therefore, the stabilization parameters may also include sensor settings, such as e.g. ODR or full scale range. For example, when a certain context is detected, a certain set of stabilization parameters is applied on the video stream, which may or may not be visible directly to the user. In parallel, variations of the set of stabilization parameters may be run, not visible to the user, and if these variations give better stabilization results. A gradual change of the set of stabilization parameters for the video stream visible to the user may be applied. The amount of parallel processing that may be done may depends on the available computing and power resources. In some embodiment, the quality analysis may not be performed on the entire frame, but rather on one or more smaller image segments. The requires the analysis of less pixels and may therefore require less resources and be faster. The size and number of image segment may depend for example on the context, the stabilization technique or the stabilization strength. The location of the segments may be predefined or based on image analysis to select representative image segments.

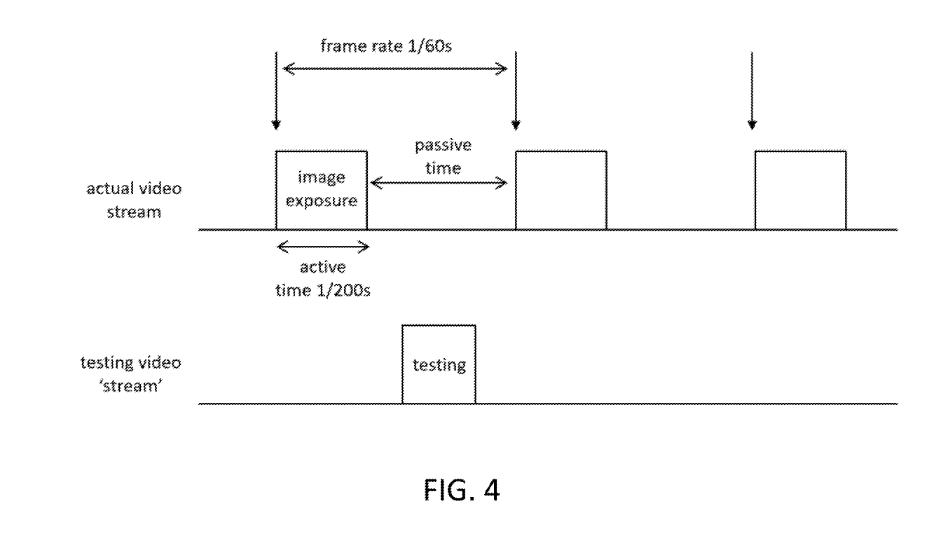

The parallel processing and testing of stabilization parameters can be applied to EIS since this involves only image processing. For OIS where the actual lens or imaging unit is moved, the processing cannot be done in parallel since it may be visible to the user. However, in some situations, testing of OIS parameters may be done sequentially, depending on the video stream and settings. For example, in 60 Hz video stream the amount of actual time used for the image capture depends on the image exposure time. If this time is small, the image capture and OIS are not active after the actual image capture process, and before the frame rate determines the start of the capture of the next image frame. This passive time may be used for testing OIS stabilization parameters. FIG. 4 shows a video stream of 60 Hz with an exposure time of 1/200 seconds, which is referred to here as the active time. The remainder of the time until the next image frame is referred to as the passive time. During this time, a variation of the OIS stabilization parameters may be tested. This testing may not be required at every image frame, but only at a predetermined rate every N number of images, at changes in context, or using some sort of test criteria. If not enough passive time is available, and testing of the OIS parameters is required, the actual image with the already selected stabilization parameter may be delayed to some extend or even completely skipped. In other words, from time to time, a regular frame with current stabilization parameter can be replaced (or delayed) by an “experimental frame” with test stabilization parameters, which will not be added to the main video stream. The skipped image may be interpolated using EIS so as not to make it visible to the user. The passive time as discussed here, may also be used for EIS testing if required.

In many use cases the user may point the camera at the scene before actually starting the recording or taking a photo. The time span from the time the camera is pointed at the scene until the start of the image capture may be used to perform or start a stabilization test phase where one or more stabilization strategies with different sets of stabilization parameters may be tested. Based on the analysis of the stabilization quality, the best set of parameters may than be selected and applied for the actual image capture. Determining the correct stabilization test time window may be crucial in order to obtain reliable results. Before the user starts the image capture, he or she often brings the camera up to approximately the desired position to point to the scene to be captured. This usually is a fast fluent motion. Next, the user will fine tune to position before starting the actually image capture. The most appropriate stabilization test time window may be after the initial large movement and during the fine tuning stage since the motion characteristics during the fine tuning may be more relevant for the actual image capture. By analyzing the motion of the camera or portable device, the optimum stabilization test time window may be determined, for example by selecting the period of low motion after the initial large motion movement. The motion patterns can also be learned for each user by recording the motion patterns before the image capture and deriving predictive patterns and storing them for each user. When using a smartphone, the start of an image capture application may be used as a trigger to start monitoring the motion in order to look for a stabilization test window. When using an SLR, the stabilization test window may be activated when the user (half) presses the trigger button, often in order to focus the lens system.

The system may also learn the typical motion characteristic of the user, such as e.g. the amplitudes of typical (hand-)shaking (under different conditions), and use these to configure the system. In such embodiments, portable device 100 may learn and adapt to usage patterns that may be specific to one or more users. For example, when a user is walking during the video recording, the system may detect the walking context and select the stabilization parameters for this context. These parameters may be selected for an average user, but may not be optimal for the current user. For example, a certain cropping percentage or settings may be selected based on average walking motion, but the user may have a different style of walking motion, and a different cropping percentage may be better suited for the image stabilization. The cropping percentage may therefore be adapted, and gradually modified, and may also be stored for the next time the walking context is detected.

The results of the stabilization analysis and the findings of what stabilization parameters work best for different contexts may also be uploaded to a remote server (or ‘cloud’). In this manner other users may also profit from the analysis. Other users may download the stabilization parameters from different context in order to obtain optimum results. The user or system may download different sets of stabilization parameters for different contexts, or the user's portable device may search for, and download, the best settings when a next context has been detected by the device. In case no connection to the remote server is possible, stored context information must be used. The stabilization parameters may be stored with corresponding information on user profiles, so that the most appropriate stabilization parameters can be found for the various users.

As mentioned above, some of the context determination may also involve obtaining a position or location of the portable device and/or the user, using e.g. a GPS device. The location may be part of the context, or help determine the context. For example, based on the GPS coordinates specific stabilization parameters may be obtained from a (remote) server. This means that users may upload and download stabilization parameters with corresponding stabilization parameters and context.

As discussed above, context manager 136 may determine the context at a specific time, which may be considered appropriate for a photograph taken within a given threshold of time. For example, the context may be classified when other parameters such as shutter speed, aperture and/or focus are determined, such as when the shutter button is half pressed (as in SLR cameras, e.g.) In some embodiments, the context may be determined substantially continuously when the image recording functionality is activated and the most recently determined classification used for setting the stabilization parameter(s) when the photograph is taken. In contrast, the context may change while recording video. Correspondingly, this may result in the change of one or more stabilization parameters.

For example, the user may start recording a video while standing still, but may starting walking at some point during the recording. In the context of EIS parameters, the cropping may be bigger when the user is walking compared to when the user is standing still, such that the crop percentage changes during the recording. As desired, stabilization manager 138 may be configured to apply changes in the parameters gradually to provide greater continuity in the resulting video. Similarly, when the user is recording and going from a brightly lit scene to a scene with low light (e.g. walking into a dark room), stabilization manager 138 may switch the stabilization technique from EIS to OIS, and again, any change in stabilization parameter may be made gradually to avoid an abrupt transition in the recorded video. For example, when switching from EIS to OIS, the cropping percentage may be decreased gradually to reach a parameter of no cropping when OIS is the sole technique being applied. The change from a first value of a stabilization parameter (e.g. cropping percentage) to a second value of the stabilization parameter over a certain time may be a linear change over time, or any other smoother variation (e.g. more of an S-curve transition). The effective value of the stabilization parameter as a function of time may be a weighted average of the first and second values. Stabilization manager 138 may also delay changes in one more stabilization parameters until a moment when the change is less likely to create an abrupt transition. For example, crop percentage may be changed when the user is zooming, since changing the cropping may have the same effect as zooming. The delay may also be decided based on image analysis, for example, when the scene is changing or objects are moving, a change in stabilization parameter may be less likely to be noticed by the user. This may create some delays in adapting the optimal settings. The changes to the stabilization parameter may be applied at different rates for different parameters, depending on the impact the parameters have on the final visual result. For example, the larger the visual effect, the slower the transition should be. When detecting a change in context, the system will determine the modification of the different parameters during the transition. The system will also determine if the change can be applied immediately or if the change in stabilization parameters should be delayed until further notice, for example when the system receives a trigger, for example based on image analysis or context changes.

As discussed, context manager 136 may include a classification function. For example, a class may be determined for different context parameters. Based on the lighting conditions, classes such as e.g. low light′, ‘medium light’ or ‘high light’ may be determined. Based on the motion conditions, classes such as e.g. ‘still’, ‘walking’, ‘panning’ may refer to the activity of the user. Based on the image analyzed, classes such as e.g. ‘no scene motion’, ‘medium scene motion’, or ‘high scene motion’ may be determined. Correspondingly, stabilization manager 138 may contain lookup tables with the desired settings for the available image stabilization systems based on the possible combinations of the different attributed classes. Different classes or combinations of classes may have the same settings, and may therefore be grouped. Different stabilization parameters or context classes may be attributed different priorities. In case any conflicting parameters or classes are detected simultaneously, the final stabilization settings can be determined with the help of the different priorities or with the help of Markov (state) machines providing estimation for the possible newly entered classes given previous state. Stabilization manager 138 may also adapt the settings depending on the use or type of the captured images. For example, the targeted optimum parameters may depend in part on whether a photograph or a video is being taken. Further examples of uses and applications that may influence one or more stabilization parameter(s) is whether the user is performing a voluntary motion (e.g. panning), or is himself moving with regard to the scene, whether subpixel stitching is being performed, whether a hyperlapse technique is applied or the like. Thus, depending on how the images are used and/or processed further afterwards may also help determine the optimal stabilization parameters, and therefore the application or type of application may influence the choice of stabilization parameters.

Stabilization manger 138 may also be configured to testing different stabilization parameter options. Image processor 120 may analyze one or more recorded images taken under different stabilization parameters to evaluate any desired characteristic in order to select appropriate parameters. When employing an EIS technique, different parameter combinations may be applied in parallel. When employing an OIS technique, subsets of images may be selected for the different parameter combinations.

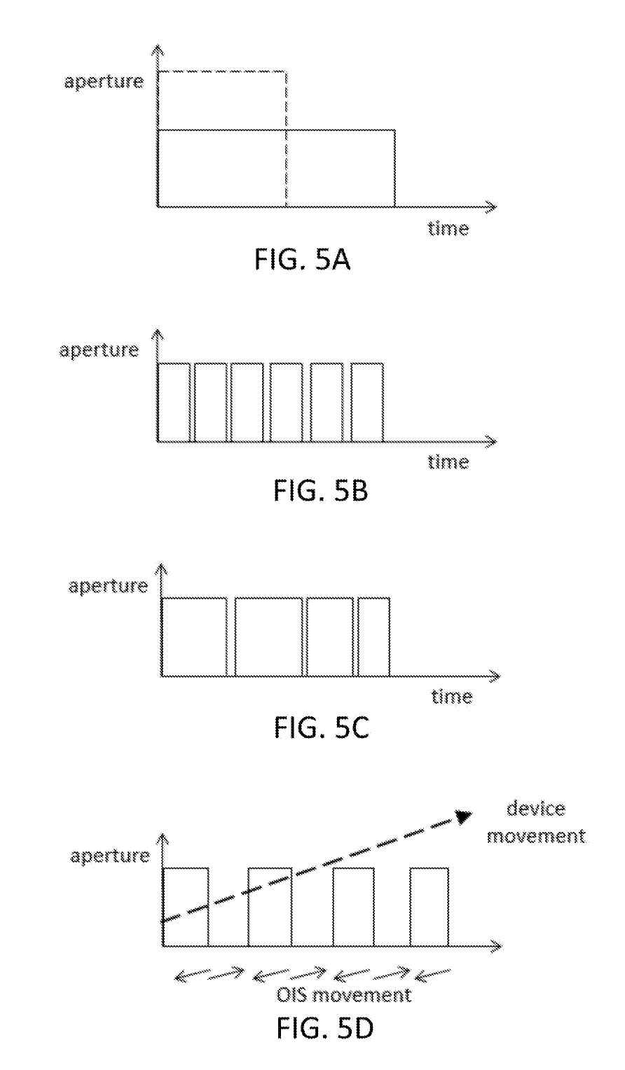

When capturing images, a certain amount of light is required to capture the scene. Depending on the lighting conditions of the scene, the camera uses a certain aperture combined with a shutter time. FIG. 5A shows an example of two different options that give the same amount of light (same surface), but for different apertures and times. For a fixed aperture, or an aperture that is already at its maximum, the only way to compensate for low light conditions is to increase the shutter time (for constant sensitivity or ISO settings). If the device is moved during the shutter time, the image may be blurred. To overcome this blur, several shorter images may be taken instead of one long image, as is shown in FIG. 5B. This reduces the amount of motion within each image by a same factor. However, each sub frame won't have enough light, so they have to be combined or added. This combination may be done using image processing, and may also be done using a motion sensor, such as e.g. a gyroscope, that tracks the movement during the sub frames. The synchronization between the sub frames and the gyroscope data may be done using time-stamping techniques or (dedicated) synchronization lines. Examples of this technique are disclosed in copending U.S. patent application Ser. No. 15/226,812, filed Aug. 2, 2016 and entitled “GYROSCOPE AND IMAGE SENSOR SYNCHRONIZATION”, which is assigned to the assignee hereof and is incorporated by reference in its entirety. Based on the gyroscope data the sub frames are aligned, and then combined, for example, by adding the aligned sub frames together. The alignment may be purely based on the gyroscope data. This means that the camera is calibrated, and taking into consideration the hardware parameter and the intrinsic camera parameters, the relation between the detected motion and the displacement of the image is known. For example, the exact amount of pixel displacement for each degree of device rotation is known, which means that sub pixel alignment is possible. Fine tuning of the sub frame alignment based on image processing may be performed after the motion sensor based alignment.

Based on the detected context, it may be decided where normal frames are used or whether a sub-frames strategy should be applied. For example, the combination of camera or object motion in combination with low light, may require sub-frames to limit motion blurring in the image. The amount of sub frames within a frame may also depend on the context and may be determined using different methods. For example, the amount of sub frames may be fixed at, e.g. 5 to 10 sub frames. If no movement is detected, the system may take a normal single frame shot, and if movement above a certain threshold is detected, the fixed amount of sub frames is used. The motion threshold may depend on the lighting conditions. In another example, the amount of sub frames increases with the amount of detected motion. Here, the lighting conditions may also influence this dependency. If motion sensors are used for aligning the sub-frames, the context and amount of sub-frames may also affect the sensor settings, such as e.g. the full scale range (FSR) or the output data rate. For example, more sub-frames means that the sub-frames have smaller exposure times and the alignment requires a higher temporal resolution, which in turn requires a higher ODR from the motion sensors.

In the examples above, the sub frames are all assumed to be substantially of equal duration. In an alternative embodiment, the sub frame duration may be determined by the amount of motion detected during the sub frame. For example, a maximum amount of allowable motion may be defined, and a new sub frame is started when this amount of motion is reached. This means that the gyroscope (or other motion sensor) determines the motion, and when it passes the maximum threshold, a signal is given to the image sensor to start a new sub frame. FIG. 5C shows an example, where in the beginning there is little motion, and so the sub frames are long, and at the end there is more motion, and thus the sub frames are longer. The maximum motion threshold may determine on the context, the user activity, and/or the image content.

In OIS systems the movements of the device by the user can be compensated by moving the lens. However, the amplitude of this correction is limited, which means the OIS can only compensate for small (vibrational) movements the user makes, such as e.g. light shaking. If the image is captures using a single frame, the OIS module can only move a certain distance. If the vibrational amplitude is larger than the OIS amplitude, sub-frames may be used to overcome this problem. When multiple sub frames are used, the OIS may be reset in between the sub frames. This means that in the time between the sub frames the OIS module is moved with the direction of the movement of the device, in order to allow for the maximum amplitude of movement against the device direction during the sub frame. FIG. 5D shows an example, where the device movement is shown by the large dashed arrow, and the OIS movement is shown by the small arrow. During the sub frame the speed of the OIS movement is defined by the device movement. In between the sub frames, only the direction of the OIS movement is defined by the direction of device movement, or more precisely, the anticipated device direction of the following sub frame. The speed of the OIS movement in between the sub frames may be the maximum possible speed of the hardware. As discussed above in detail, whether or not to use OIS may depend on the detected context.

In one aspect, stabilizing the image may include distinguishing intended motion from unintended motion and compensating for unintended motion as the image is captured. As such, stabilizing the image may include compensating for unintended motion of the captured image with respect to at least one of a sequence of images including the captured image. Different stabilization parameters may be applied separately to the intended and unintended motion if possible. The presence of intended motion, or the ratio of intended and unintended motion may also be used to determine the stabilization parameters and settings.

In one aspect, the stabilization parameter may disable image stabilization for at least the captured image.

In one aspect, stabilizing the image may include an electronic image stabilization (EIS) technique. The stabilization parameter may control an amount of cropping or may control a maximum amplitude of displacement of the captured image with respect to at least one of a sequence of images including the captured image. The stabilization parameter may be a temporal filtering parameter, a spatial correction parameter, a motion threshold and/or a sensor parameter. The stabilization parameter may also be a number of images in a sequence of images including the captured image to be used when stabilizing the captured image, a number of sub-frames for the image capture, and/or duration of the sub-frames.

In one aspect, stabilizing the image may include an optical image stabilization (OIS) technique. The stabilization parameter may be a maximum amplitude of an actuator of an OIS system and/or a permitted frequency range for actuator operation.

In one aspect, the stabilization parameter may include selection between applying an EIS technique and an OIS technique.

In one aspect, the stabilization parameter may include a relative weighting of an EIS technique and an OIS technique.

In one aspect, the stabilizing may be at least one of an intra-frame stabilization and an inter-frame stabilization.

In one aspect, the sensor may be a motion sensor and the establishing the context may include determining a quantity of energy for at least one motion frequency range.

In one aspect, the context may depend on an ambient light condition of the portable device; motion of the portable device; motion of a platform conveying the portable device; motion of the portable device; an ambient light condition of the device; an audio stream captured by a sensor of the portable device; an image stream captured by the portable device; and a location of the portable device; and/or a resource level of the portable device.

In one aspect, the sensor data may be obtained from the image sensor, a light sensor, a motion sensor, proximity sensor; location sensor; pressure sensor; humidity sensor, and temperature sensor.

In one aspect, the stabilization parameter may be based at least in part on change in the determined context.

In one aspect, a second context may be detected different from the first context, the second context being associated with a second set of stabilization parameters different from a first set of stabilization parameters associated with the first context. The change from the first set of stabilization parameters to the second set of stabilization parameters may be gradually applied. The change from the first set of stabilization parameters to the second set of stabilization parameters may be applied with a delay. The delay may be based on at least one of image content, a user action, modification of the image capture process.

In one aspect, the stabilization parameter may be based at least in part on an intended use of the captured image.

In one aspect, the sensor may be integrated with the portable device.

In one aspect, the sensor may be integrated with an auxiliary device that may be in communication with the portable device.

In one aspect, the context may be also based at least in part on a location at which the image may be captured.

In one aspect, the method may also involve uploading stabilization data to a remote server, the stabilization data including stabilization parameters, context, sensor data, location, results of evaluation of the stabilized image, information about the user, and information about the image content.

In one aspect, the method may involve obtaining at least one stabilization parameter from a remote server based on at least one of location, context, sensor data, user profile.

In one aspect, the stabilized image may be evaluated and the stabilization parameter may be adjusted based at least in part on the evaluation. The evaluation may be performed within a stabilization test window and the stabilization test window may be based on the sensor data.

In one aspect, different sets of stabilization parameters may be applied to the same video stream, the stabilized image stream may be evaluated and one of the sets of stabilization parameters may be selected based at least in part on the evaluation.

In one aspect, a first set of stabilization parameters may be applied to a series of sequential images, and a second set of stabilization parameters may be applied to at least one image in between two sequential images.

As described above, the disclosure also includes a portable device. In one aspect, the stabilization manager obtains at least one of sensor data and context data from a second device in communication with the portable device. The portable device may also be configured to request context data. The second device may send context data or changes in context data to the portable device.

As described above, the disclosure also includes system comprising the portable device and an auxiliary device that outputs data to the context manager of the portable device. In one aspect, the system may also include a remote server in communication with the portable device, wherein the portable device may obtain at least one of stabilization parameters and context from the remote server.

Although the present invention has been described in accordance with the embodiments shown, one of ordinary skill in the art will readily recognize that there could be variations to the embodiments and those variations would be within the spirit and scope of the present invention. For example, although the techniques have been described in reference to applying a stabilization technique, other image effects may be applied based on the detected context, such as enhancing or modifying the image to reflect the context image content. For example, when taking an image or video of a party, the image effects may be used to enhance the party atmosphere, or when taking a photo of a landscape, the image effects may be used to enhance the depth of the scene. Accordingly, many modifications may be made by one of ordinary skill in the art without departing from the spirit and scope of the present invention.

What is claimed is:

1. A method for processing an image captured with a portable device comprising:
obtaining data from a sensor representative of a condition of the portable device;
establishing a context of the portable device based at least in part on the sensor data;
determining a stabilization parameter based at least in part on the context; and
stabilizing an image captured from an image sensor of the portable device based at least in part on the stabilization parameter.

2. The method of claim 1, wherein stabilizing the image comprises distinguishing intended motion from unintended motion and compensating for unintended motion as the image is captured.

3. The method of claim 2, wherein stabilizing the image comprises compensating for unintended motion of the captured image with respect to at least one of a sequence of images including the captured image.

4. The method of claim 1, wherein the stabilization parameter disables image stabilization for at least the captured image.

5. The method of claim 1, wherein stabilizing the image comprises an electronic image stabilization (EIS) technique.

6. The method of claim 5, wherein the stabilization parameter is at least one parameter selected from the group consisting of a parameter that controls an amount of cropping; a parameter that controls a maximum amplitude of displacement of the captured image with respect to at least one of a sequence of images including the captured image; a temporal filtering parameter; a spatial correction parameter; a motion threshold; a sensor parameter; a number of images in a sequence of images including the captured image used when stabilizing the captured image; a number of sub-frames for the image capture; and duration of the sub-frames.

7. The method of claim 1, wherein stabilizing the image comprises an optical image stabilization (OIS) technique.

8. The method of claim 7, wherein the stabilization parameter comprises at least one selected from the group consisting of a maximum amplitude and a maximum frequency of motion of an actuator of an OIS system.

9. The method of claim 1, wherein the stabilization parameter comprises a relative weighting of an EIS technique and an OIS technique.

10. The method of claim 1, wherein the stabilizing comprises selecting at least one of an intra-frame stabilization and an inter-frame stabilization.

11. The method of claim 1, wherein the sensor comprises a motion sensor and the establishing the context comprises determining a quantity of energy for at least one motion frequency range.

12. The method of claim 1, wherein the context depends on at least on one of the group consisting of an ambient light condition of the portable device; a motion of the portable device; a motion of a platform conveying the portable device; an audio stream captured by a sensor of the portable device; an image stream captured by the portable device; and a location of the portable device; and a resource level of the portable device.

13. The method of claim 1, wherein the sensor data is obtained from at least one sensor selected from the group consisting of the image sensor; a light sensor; a motion sensor; proximity sensor; location sensor; pressure sensor; humidity sensor; and temperature sensor.

14. The method of claim 1, wherein the stabilization parameter is based at least in part on change in the determined context.

15. The method of claim 1, wherein a second context is detected different from the first context, the second context being associated with a second set of stabilization parameters different from a first set of stabilization parameters associated with the first context.

16. The method of claim 15, wherein the change from the first set of stabilization parameters to the second set of stabilization parameters is gradually applied.

17. The method of claim 15, wherein the change from the first set of stabilization parameters to the second set of stabilization parameters is applied with a delay.

18. The method of claim 17, wherein the delay is based on at least one of image content, a user action, modification of the image capture process.

19. The method of claim 1, wherein the stabilization parameter is based at least in part on an intended use of the captured image.

20. The method of claim 1, wherein the context is also based at least in part on a location at which the image is captured.

21. The method of claim 1, further comprising uploading stabilization data to a remote server, the stabilization data containing at least one of the group consisting of stabilization parameters, context, sensor data, location, results of evaluation of the stabilized image, information about the user, and information about the image content.

22. The method of claim 1, further comprising obtaining at least one stabilization parameter from a remote server based on at least one of location, context, sensor data, user profile.

23. The method of claim 1, further comprising evaluating the stabilized image and adjusting the stabilization parameter based at least in part on the evaluation.

24. The method of claim 1, further comprising applying different sets of stabilization parameters to a first video stream; evaluating the stabilized image streams; and selecting one of the sets of stabilization parameters based at least in part on the evaluation.

25. The method of claim 24, wherein a first set of stabilization parameters is applied to a series of sequential images, and a second set of stabilization parameters is applied to at least one image in between two sequential images.

26. The method of claim 23, wherein the evaluating is performed within a stabilization test window, and the stabilization test window is determined based on the sensor data.

28. A portable device comprising:
an image sensor;
a context manager for obtaining sensor data and establishing a context of the portable device based at least in part on the sensor data;
a stabilization manager for determining a stabilization parameter based at least in part on the context; and
an image processor for stabilizing an image captured from the image sensor based at least in part on the stabilization parameter.

29. The portable device of claim 28, wherein the stabilization manager obtains at least one of sensor data and context data from a second device in communication with the portable device.

30. The portable device of claim 29, wherein the portable device requests context data.

31. The portable device of claim 29, wherein the second device communicates changes in context data to the portable device.

32. A system for stabilizing an image, comprising:
a portable device having:
an image sensor;
a context manager for obtaining sensor data and establishing a context of the portable device based at least in part on the sensor data;
a stabilization manager for determining a stabilization parameter based at least in part on the context; and
an image processor for stabilizing an image captured from the image sensor based at least in part on the stabilization parameter; and
an auxiliary device having a motion sensor that outputs data to the context manager of the portable device.

33. The system of claim 32, further comprising a remote server in communication with the portable device, wherein the portable device obtains at least one of stabilization parameters and context from the remote server.
